(19) United States
(12) Patent Application Publication
(10) Pub. No.: US 2014/0334729 A1
(43) Pub. Date: Nov. 13, 2014

(54) IMAGE PROCESSING APPARATUS AND IMAGE PROCESSING METHOD

(71) Applicant: CANON KABUSHIKI KAISHA, Tokyo (JP)

(72) Inventors: Yoshihiro Manabe, Yokohama-shi (JP); Kosei Takahashi, Kawasaki-shi (JP)

(73) Assignee: CANON KABUSHIKI KAISHA, Tokyo (JP)

(21) Appl. No.: 14/274,433

(22) Filed: May 9, 2014

(30) Foreign Application Priority Data
May 13, 2013 (JP) 2013-101518

(51) Int. Cl. G06T 7/40

(52) U.S. Cl. CPC G06T 7/408
USPC 382/167

(57) ABSTRACT

An image processing apparatus includes a first conversion unit configured to convert captured image data based on light source information under shooting illumination, and a second conversion unit configured to convert captured image data that has been converted by the first conversion unit, based on white balance setting information and the light source information.

### BACKGROUND OF THE INVENTION

1. Field of the Invention

The present invention generally relates to image processing and, more particularly, to an image processing apparatus, an image processing method, and to color conversion processing in white balance processing.

2. Description of the Related Art

Typically, when shooting with a digital camera, white balance processing is carried out inside the camera so that the white color under the shooting illumination has mutually equal red, green, and blue (RGB) signal values. Japanese Patent Application Laid-Open No. 2006-319830 discusses a technique by which a shooting light source is inferred based on an image signal obtained by shooting the white color and the RGB values are adjusted based on light source parameters corresponding to the inferred shooting light source such that the white color under the shooting illumination becomes achromatic.

Meanwhile, there is a case in which a scene is shot with white balance settings that differ from those of the actual light source to retain an atmosphere of the illumination of the shooting scene. For example, in shooting under red illumination at 3000 K, if the white balance of the camera is set to 5500 K, which is higher than the color temperature of the illumination, the white color can be recorded in a reddish color. Such a shooting method is used in photographing and video shooting for movies or the like.

In the white balance processing through an RGB gain adjustment as described above, however, chromatic adaptation is not taken into consideration, and thus the aforementioned technique presents a problem in that color conversion accuracy degrades with respect to colors perceived by a person, except the white color. As a result, colors in an image obtained by shooting under a white balance that differs from that of the light source characteristics of the shooting scene are recognized as colors that are different from the colors perceived by a person who has adapted to the set white balance.

### SUMMARY OF THE INVENTION

The present disclosure is directed to providing image processing for improving color conversion accuracy even in a case of shooting under a white balance that differs from that of the light source characteristics of a shooting scene.

An image processing apparatus according to an aspect of the present disclosure includes a first conversion unit configured to convert captured image data, based on light source information under shooting illumination, and a second conversion unit configured to convert captured image data that has been converted by the first conversion unit, based on white balance setting information and the light source information.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a digital camera.

FIG. 2 is a block diagram illustrating a configuration of a computer system.

FIG. 3 is a block diagram illustrating a configuration for carrying out image processing according to a first exemplary embodiment.

FIG. 4 is a flowchart of the image processing according to the first exemplary embodiment.

FIG. 5 is a block diagram illustrating a configuration for carrying out image processing according to a second exemplary embodiment.

FIG. 6 is a flowchart of the image processing according to the second exemplary embodiment.

FIG. 7 is a block diagram illustrating a configuration for carrying out image processing according to a third exemplary embodiment.

FIG. 8 is a flowchart illustrating the image processing according to the third exemplary embodiment.

FIG. 9 is a block diagram illustrating a configuration for carrying out image processing according to a fourth exemplary embodiment.

FIG. 10 is a flowchart illustrating the image processing according to the fourth exemplary embodiment.

FIG. 11 illustrates an example of a user interface in the fourth exemplary embodiment.

### DESCRIPTION OF THE EMBODIMENTS

Various exemplary embodiments, features, and aspects of the disclosure will be described in detail below with reference to the drawings.

In the subsequent descriptions, identical configurations are given identical reference characters.

### <Configuration of Digital Camera>

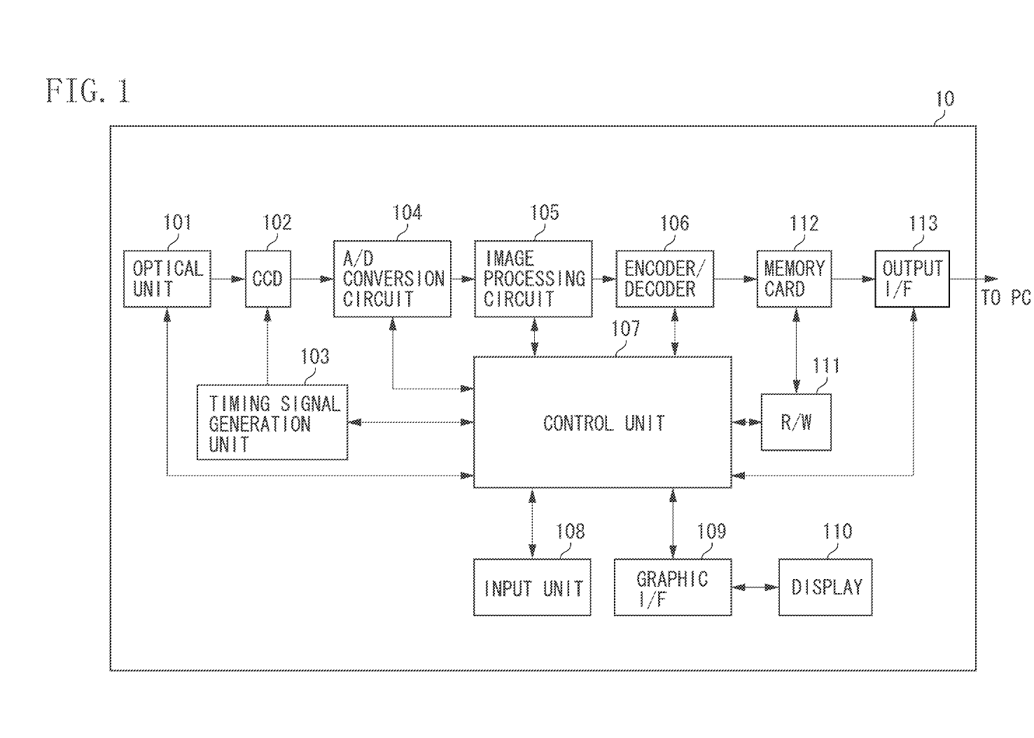

Hereinafter, a first exemplary embodiment will be described. FIG. 1 illustrates a configuration of a digital still camera 10 (hereinafter, also referred to as a digital camera) serving as an image capturing apparatus. The digital camera 10 includes an optical unit 101, a charge-coupled device (CCD) 102, a timing signal generation unit 103, an analog/digital (A/D) conversion circuit 104, an image processing circuit 105, an encoder/decoder 106, a control unit 107, an input unit 108, and a graphic interface (I/F) 109. The digital camera 10 further includes a display 110, a reader/writer (R/W) 111, a memory card 112, and an output I/F 113. As used herein, the term “unit” generally refers to any combination of software, firmware, hardware, or other component that is used to effectuate a purpose.

Among the aforementioned components, the optical unit 101, the timing signal generation unit 103, the A/D conversion circuit 104, the image processing circuit 105, the encoder/decoder 106, the input unit 108, the graphic I/F 109, the R/W 111, and the output I/F 113 are connected to the control unit 107.

The optical unit 101 includes a lens for converging light from an object onto the CCD 102, a drive mechanism for moving the lens to adjust its focus or to zoom in/out, a shutter mechanism, an iris mechanism, and so on. The stated components are driven based on a control signal from the control unit 107.

The CCD 102 is driven based on a timing signal output from the timing signal generation unit 103 to convert incident light from the object to an electric signal.

The timing signal generation unit 103 outputs a timing signal under the control of the control unit 107.

The A/D conversion circuit 104 carries out A/D conversion of an image signal output from the CCD 102 to output a digital image signal.

The image processing circuit 105 carries out, on a digital image signal output from the A/D conversion circuit 104, some or all of the camera signal processing operations including demosaicing processing, white balance processing, color correction processing, auto-focus (AF) processing, and automatic exposure (AE) processing.

The encoder/decoder 106 carries out encoding (compression) processing of a predetermined still image data format, such as a joint photographic expert group (JPEG) format, on an image signal output from the image processing circuit 105. In addition, the encoder/decoder 106 carries out decoding (decompression) processing on encoded data of a still image supplied from the control unit 107.

The control unit 107, which is a microcontroller including, for example, a central processing unit (CPU), a read only memory (ROM), and a random access memory (RAM), executes a program stored in the ROM or the like to control the entire components of the digital camera 10.

The input unit 108 includes various operation keys including a shutter relief button, a lever, a dial, and so on and outputs, to the control unit 107, a control signal that corresponds to an operation input by a user.

The graphic I/F 109 generates, from an image signal supplied from the control unit 107, an image signal that causes the display 110 to display an image and then supplies the generated image signal to the display 110, which in turn displays an image.

The display 110, which is, for example, a liquid crystal display, displays a through-the-lens image that is being captured, an image obtained by reproducing recorded data, and so on.

The memory card 112, which includes a portable flash memory and serves as a recording medium that records image data and so on generated by capturing an image, is connected to the R/W 111. The R/W 111 writes data supplied from the control unit 107 onto the display 110 and also outputs data loaded from the memory card 112 to the control unit 107. A writable optical disc, a hard disk drive (HDD), or the like, may also be used as such a recording medium.

The output I/F 113 is a connection terminal such as a universal serial bus (USB), a high-definition multimedia interface (HDMI) (registered trademark), and a high-definition serial digital interface (HD-SDI). The output I/F 113 transmits an image signal recorded on the memory card 112 to an external device such as a personal computer (PC).

### <Operation of Digital Camera>

A basic operation of the digital camera 10 will now be described.

Prior to capturing an image, light is received by the CCD 102, and a signal is obtained through photoelectric conversion of the received light. The obtained signal is supplied, one after another, to the A/D conversion circuit 104. The A/D conversion circuit 104 then converts the supplied signal to a digital signal.

The image processing circuit 105 carries out image quality correction processing based on the digital image signal supplied from the A/D conversion circuit 104 and supplies the corrected signal as a through-the-lens image signal to the graphic I/F 109 via the control unit 107. Thus, the through-the-lens image is displayed on the display 110, and the user can adjust the angle of view while viewing the display 110.

In this state, the user makes, through the input unit 108, white balance settings for recording an image. When the user presses a shutter relief button in the input unit 108, the control unit 107 outputs control signals to the optical unit 101 and the timing signal generation circuit 103 to operate a shutter in the optical unit 101. Thus, an image signal is output from the CCD 102.

The image processing circuit 105 subjects the image signal supplied from the CCD 102 through the A/D conversion circuit 104 to the image quality correction processing based on a user input and supplies the processed image signal to the encoder/decoder 106.

The encoder/decoder 106 encodes (compresses) the input image signal and supplies the generated encoded data to the R/W 111 through the control unit 107. Then, captured image data and shooting conditions such as the white balance settings and the light source information of the shooting scene are recorded onto the memory card 112.

If the digital camera 10 is connected to an external device such as a PC, the digital camera 10 outputs the image data and the shooting condition information recorded on the memory card 112 to the external device through the output I/F 113.

Note that the CCD 102 is not limited to a CCD, and an image sensor of a different system such as a complementary metal-oxide semiconductor (CMOS) may instead be used.

### <Configuration of Computer System>

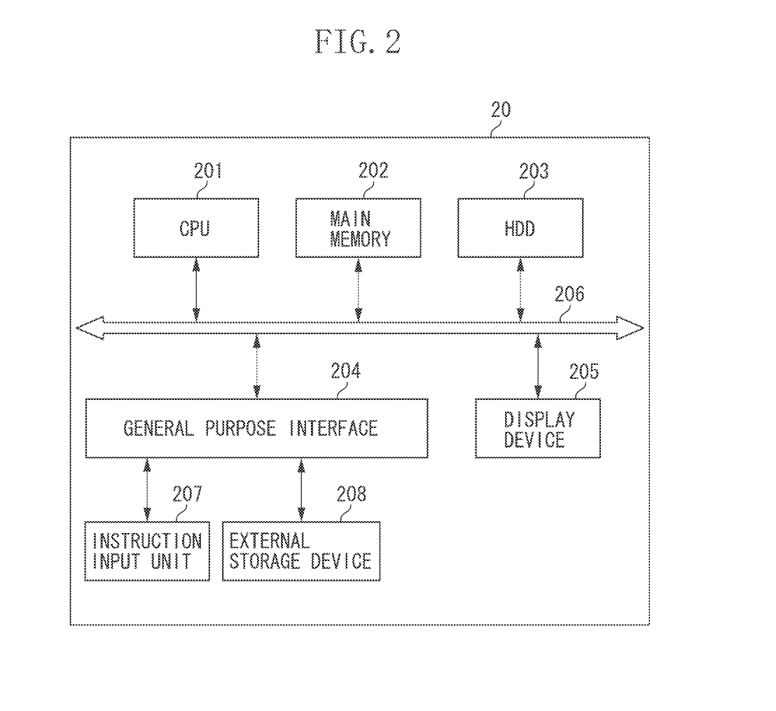

FIG. 2 illustrates a configuration of a computer system 20. The computer system 20 includes a CPU 201, a main memory 202, an HDD 203, a general purpose interface 204, a display device 205, a main bus 206, an instruction input unit 207 such as a keyboard and a mouse, and an external storage device 208. The general purpose interface 204 connects the instruction input unit 207, the external storage device 208, and so on to the main bus 206.

### <Operation of Computer System>

Hereinafter, various processing operations that are implemented as the CPU 201 executes software (computer program) stored in the HDD 203 will be described. First, the CPU 201 starts a computer program, which serves as software of the image processing apparatus, stored in the HDD 203 or the external storage device 208, in response to a user instruction input through the instruction input unit 207. The CPU 201 then deploys an application in the main memory 202 and also displays a user interface on the display device 205 serving as a monitor.

Subsequently, various pieces of data stored in the HDD 203 or the external storage device 208 are transferred to the main memory 202 via the main bus 206 in accordance with an instruction from the CPU 201. The various pieces of data transferred to the main memory 202 are then subjected to predetermined calculation processing in accordance with an instruction from the CPU 201, and the result obtained through the calculation processing is displayed on the display device 205 or stored in the HDD 203 or the external storage device 208 via the main bus 206.

### <Configuration for Image Processing>

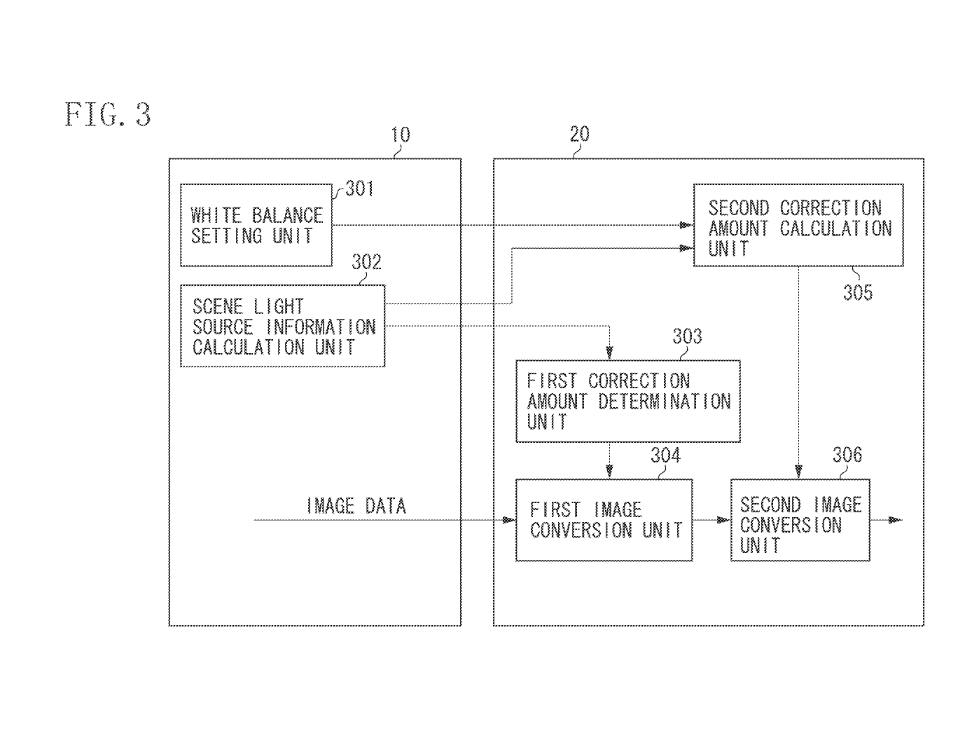

Processing through which the CPU 201 of the computer system 20 serving as the image processing apparatus carries out color correction on image data in the digital camera 10 will now be described with reference to FIG. 3.

Referring to FIG. 3, a white balance setting unit 301 sets the white balance setting information specified by the user through the input unit 108.

A scene light source information calculation unit 302 calculates information on a light source of a shooting scene (i.e., light source information of shooting illumination). The scene light source information calculation unit 302 may be a calculation circuit that calculates the information on the light source of the shooting scene (hereinafter, also referred to as a scene) from an image signal or may be a sensor, separate from the CCD 102, that measures and outputs spectral information.

A first correction amount determination unit 303 determines a correction amount for carrying out first correction processing, based on the information from the scene light source information calculation unit 302.

A first image conversion unit 304 carries out the first correction processing based on the correction amount determined by the first correction amount determination unit 303.

A second correction amount calculation unit 305 calculates a correction amount for second correction processing by using the setting information set by the white balance setting unit 301 and the information from the scene light source information calculation unit 302.

A second image conversion unit 306 carries out second image correction processing based on the result obtained by the second correction amount calculation unit 304.

### <Operation in Image Processing>

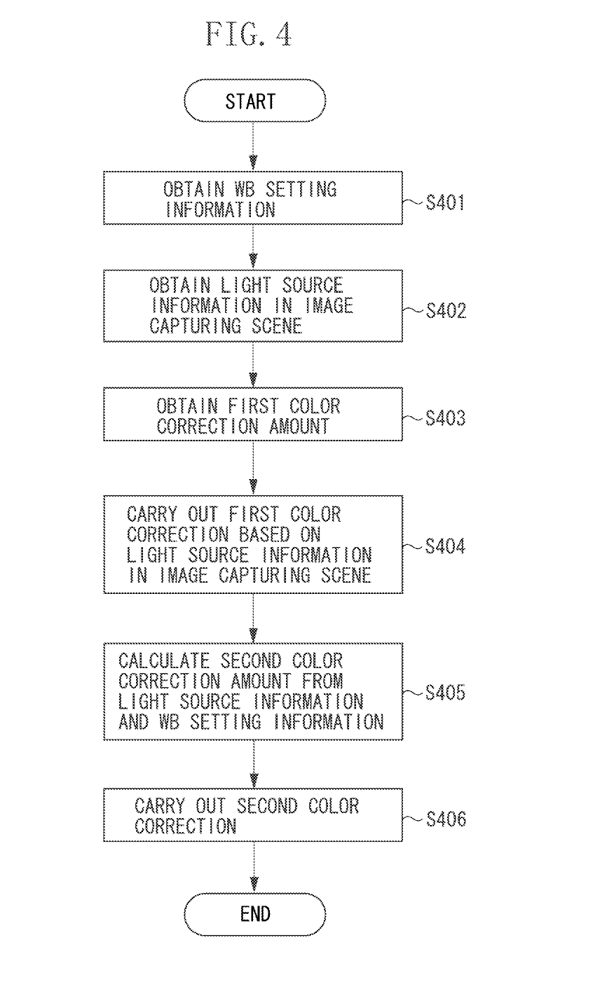

FIG. 4 is a flowchart of the image processing according to the first exemplary embodiment.

In step S401, the second correction amount calculation unit 305 obtains the white balance setting information that has been set in the digital camera 10 by the white balance setting unit 301. The setting information may include, for example, the name of the light source, such as D50, D65, and A, or a color temperature, as 3000 K and 5000 K.

In step S402, the first correction amount determination unit 303 and the second correction amount calculation unit 305 obtain the light source information of the shooting scene from the scene light source information calculation unit 302. The scene light source information calculation unit 302 may calculate the light source information of the shooting scene through any given method. In the first exemplary embodiment, the scene light source information calculation unit 302 calculates, as the light source information of the shooting scene, pixel values R_{w}G_{w}B_{w} in which a pixel value (signal value) of G is at a maximum among the image data that is yet to be subjected to white balance correction. Alternatively, a spectral sensor may, for example, be provided in the digital camera 10, and the pixel values R_{w}G_{w}B_{w} may be calculated by analyzing output values of spectral radiance obtained by the spectral sensor and color filter characteristics retained in advance in the digital camera 10. As yet another alternative, the user may specify the light source information of the shooting scene prior to shooting, and a plurality of sets indicating correspondence relationships between the light source information and RGB values may be retained in advance. The pixel values R_{w}G_{w}B_{w} may then be calculated by obtaining, from the aforementioned sets, an RGB value that corresponds to the specified light source information.

In step S403, the first correction amount determination unit 303 selects a transformation matrix M from a plurality of transformation matrices prepared in advance, corresponding to the light source information of the shooting scene, and sets the selected transformation matrix M as a correction amount. The plurality of transformation matrices indicates correction amounts for transforming the RGB values of captured data to a common color space. The transformation matrices differ according to light source information of the shooting scene, and, in step S403, an optimal matrix is selected in accordance with the scene.

$$M = ( \begin{matrix}m 11 & m 12 & m 13 \\ m 21 & m 22 & m 23 \\ m 31 & m 32 & m 33\end{matrix} ) \qquad ( 1 )$$

In step S404, the first image conversion unit 304 carries out the first color correction processing based on the correction amount obtained in step S403. In the first exemplary embodiment, the first image conversion unit 304 carries out the white balance processing on the RGB signal values which are the captured image data serving as the input image data, based on the light source information of the shooting scene to convert the RGB signal values into numerical values representing a given color. In the first exemplary embodiment, the first image conversion unit 304 converts the RGB signal values into, for example, XYZ values of tristimulus values. Note that the white balance processing is carried out in a case in which the input image data is in a RAW format. The white balance processing is not necessary in a case in which the input image data is in a debayered format such as the JPEG format.

First, the first image conversion unit 304 carries out the white balance processing according to Expression (2).

R′=R×G_{w}/R_{w}

G′=G

B′=B×G_{w}/B_{w}

Subsequently, the first image conversion unit 304 transforms the RGB signal values to XYZ values according to Expression (3).

$$( \begin{matrix}X \\ Y \\ Z\end{matrix} ) = M \times ( \begin{matrix}R \\ G \\ B\end{matrix} ) \qquad ( 3 )$$

Although the matrix M in Expression (3) serves to transform the camera RGB to the tristimulus values XYZ in the first exemplary embodiment, an exemplary embodiment is not limited thereto. For example, the matrix M in Expression (3) may transform the camera RGB to a standard color space such as sRGB, Adobe RGB, and academy color encoding system (ACES) RGB. Here, a regular transformation may be used to transform RGB of a standard color space to XYZ.

In step S405, the second correction amount calculation unit 305 calculates second correction amount by using the white balance setting information obtained in step S401 and the light source information of the shooting scene obtained in step S402. The second correction amount calculation unit 305 holds in advance a plurality of sets indicating correspondence relationship between the white balance setting information and the tristimulus values XYZ, and loads, from the stated sets, tristimulus values X_{wb}Y_{wb}Z_{wb} of the white color that corresponds to the white balance setting information. Here, the value of Y_{wb} is normalized to 1.0. The XYZ is then transformed to L_{wb}M_{wb}S_{wb}, which represents LMS cone sensitivity in human vision, according to Expression (4). Through this transformation, the XYZ can be transformed into a perceived quantity perceived by human cones. Although a known transformation defined as CAT02 is used in the first exemplary embodiment, another transformation such as the Bradford transformation may instead be used.

$$( \begin{matrix}{L}_{wb} \\ {M}_{wb} \\ {S}_{wb}\end{matrix} ) = CAT 02 ( \begin{matrix}{X}_{wb} \\ {Y}_{wb} \\ {Z}_{wb}\end{matrix} ) \\ CAT 02 = ( \begin{matrix}0.7328 & 0.4296 & - 0.1624 \\ - 0.7036 & 1.5975 & 0.0061 \\ 0.0030 & 0.0136 & 0.9834\end{matrix} ) \qquad ( 4 )$$

Subsequently, the second correction amount calculation unit 305 transforms the R_{w}G_{w}B_{w} values that represent the white color of the shooting scene obtained from the light source information of the shooting scene, into X_{w}Y_{w}Z_{w} by using Expressions (1) and (3). The second correction amount calculation unit 305 then transforms X_{w}Y_{w}Z_{w} into L_{scene}M_{scene}S_{scene} that represents the LMS cone sensitivity, serving as a perceived quantity of the human cones by using Expression (5) below in a similar manner to Expression (4).

$$( \begin{matrix}{L}_{scene} \\ {M}_{scene} \\ {S}_{scene}\end{matrix} ) = CAT 02 ( \begin{matrix}{X}_{w} / {Y}_{w} \\ {Y}_{w} / {Y}_{w} \\ {Z}_{w} / {Y}_{w}\end{matrix} ) \qquad ( 5 )$$

Lastly, the second correction amount calculation unit 305 calculates gain_L, gain_M, and gain_S, serving as the second correction amount, by using Expression (6) from the results obtained according to Expressions (4) and (5).

gain_{—}L=L_{scene}/L_{wb}

gain_{—}M=M_{scene}/M_{wb}

gain_{—}S=S_{scene}/S_{wb} (6)

In step S406, the second image conversion unit 306 corrects the image signal by using the correction amount calculated in step S405. This correction amount indicates a ratio of the perceived quantity of the white color in the scene to the perceived quantity of the white color in the white balance, in the LMS cones. By using this correction amount, colors in the image signal can be converted to colors that are perceived when a person has adapted to the white color set in the white balance. First, by using Expression (7) below, the second image conversion unit 306 transforms XYZ obtained in step S404 to LMS information as in step S405.

$$( \begin{matrix}L \\ M \\ S\end{matrix} ) = CAT 02 ( \begin{matrix}X \\ Y \\ Z\end{matrix} ) \qquad ( 7 )$$

Subsequently, the second image conversion unit 306 calculates L′M′S′ by multiplying LMS by the correction amount obtained in step S405 according to Expression (8) below.

L′=L×gain_{—}L

M′=M×gain_{—}M

S′=S×gain_{—}S (8)

The second image conversion unit 306 then transforms L′M′S′ into tristimulus values X′Y′Z′.

$$( \begin{matrix}{X}^{′} \\ {Y}^{′} \\ {Z}^{′}\end{matrix} ) = CAT {02}^{- 1} ( \begin{matrix}{L}^{′} \\ {M}^{′} \\ {S}^{′}\end{matrix} ) \qquad ( 9 )$$

Lastly, the second image conversion unit 306 transforms the tristimulus values X′Y′Z′ into R′G′B′ of the camera RGB values.

$$( \begin{matrix}{R}^{′} \\ {G}^{′} \\ {B}^{′}\end{matrix} ) = {M}^{- 1} ( \begin{matrix}{X}^{′} \\ {Y}^{′} \\ {Z}^{′}\end{matrix} ) \qquad ( 10 )$$

Thus, the operation of the image processing apparatus of the first exemplary embodiment ends.

Although the tristimulus values X_{wb}Y_{wb}Z_{wb} of the white color that corresponds to the white balance setting information obtained in step S401 has been obtained in step S405 in the preceding description, the tristimulus values X_{wb}Y_{wb}Z_{wb} may be obtained in step S401.

As described thus far, according to the first exemplary embodiment, the color conversion accuracy is maintained through the color conversion based on the shooting scene, and then the color correction is carried out based on the white balance settings. Thus, an image can be converted with high accuracy by taking the illumination used at the time of shooting and the white balance settings into consideration. In addition, the first exemplary embodiment of the present disclosure has an advantage in that a memory capacity can be reduced, since only a number of transformation profiles need to be retained that corresponds to the number of types of shooting scenes, instead of retaining transformation matrices serving as transformation profiles for each set of the shooting scenes and the white balance settings.

Although the present disclosure has been described based on the configuration including a digital camera and a computer system according to the first exemplary embodiment, similar processing can be implemented even with a configuration including only the digital camera which integrates processing of the computer system therein.

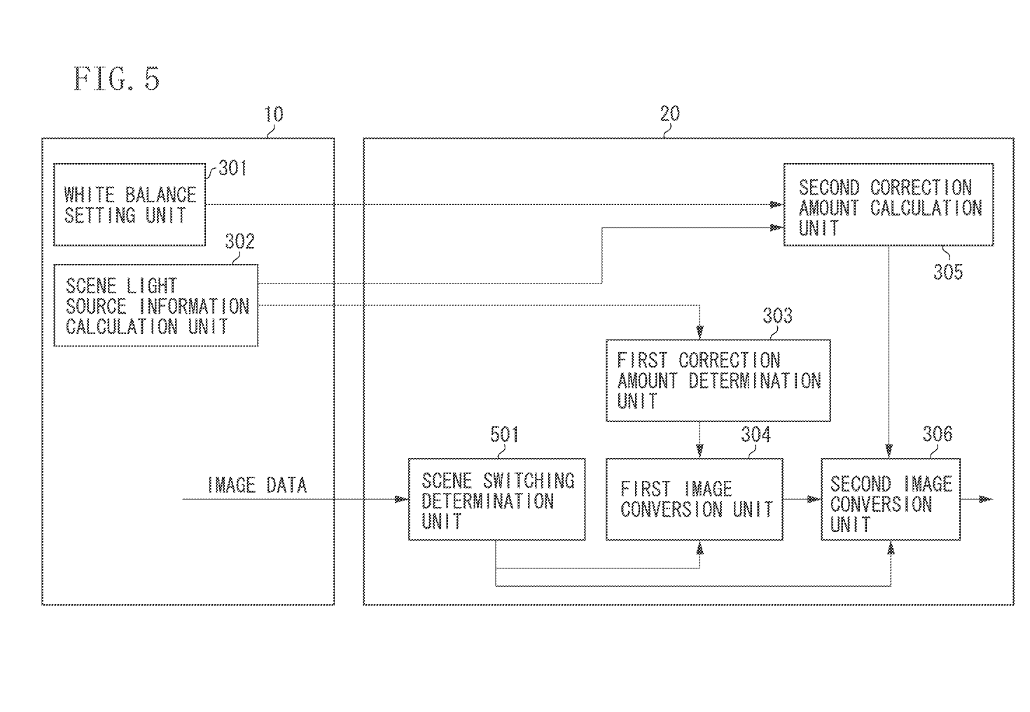

In the first exemplary embodiment, the image processing to be carried out when a still image is captured has been described. In a second exemplary embodiment, image processing to be carried out when a moving image is captured will be described. Primarily, features that differ from those of the first exemplary embodiment will be described in brief. Although the configurations of the digital video camera and the computer system are the same as those of the first exemplary embodiment, the configuration of the computer system 20 illustrated in FIG. 5 differs from that of the first exemplary embodiment.

### <Configuration of Video Camera>

The configuration of the digital video camera of the second exemplary embodiment will now be described with reference to FIG. 1. As in the digital camera 10, the digital video camera of the second exemplary embodiment also includes the optical unit 101, the CCD 102, the timing signal generation unit 103, the A/D conversion circuit 104, the image processing circuit 105, the encoder/decoder 106, the control unit 107, the input unit 108, the graphic I/F 109, the display 110, the R/W 111, the memory card 112, and the output I/F 113.

The timing signal generation unit 103 generates a signal at a constant time interval in accordance with a frame rate (the number of frames per second) of a moving image to be captured.

The encoder/decoder 106 carries out encoding processing (compression) of a predetermined moving image data format, such as H.264, audio visual interleaved (AVI), digital picture exchange (DPX), and RAW, on the image signal from the image processing circuit 105.

### <Operation of Video Camera>

The basic operation of the above-described digital video camera will now be described with reference to FIG. 1 focusing on differences from the operation in the first exemplary embodiment.

The user sets, in addition to the white balance settings for recording a moving image, the resolution and the frame rate of the moving image through the input unit 108.

When the user presses a moving image recording start button through the input unit 108, the control unit 107 outputs control signals at time intervals corresponding to the frame rate, to the optical unit 101 and the timing signal generation circuit 103 to operate a shutter in the optical unit 101. Through this, image signals are output from the CCD 102 at constant time intervals. Thereafter, the recording operation is repeated similar to the first exemplary embodiment until the user presses a moving image recording finish button through the input unit 108.

### <Configuration of Image Processing Apparatus>

Processing through which the CPU 201 of the computer system serving as the image processing apparatus carries out color correction on the image data in the digital video camera will now be described with reference to FIG. 5. Referring to FIG. 5, the white balance setting unit 301, the scene light source information calculation unit 302, the first correction amount determination unit 303, the first image conversion unit 304, the second correction amount calculation unit 305, and the second image conversion unit 306 are the same as those in the first exemplary embodiment. A scene switching determination unit 501 determines whether a scene has been switched based on an image signal and information belonging to the image signal.

### <Operation of Image Processing>

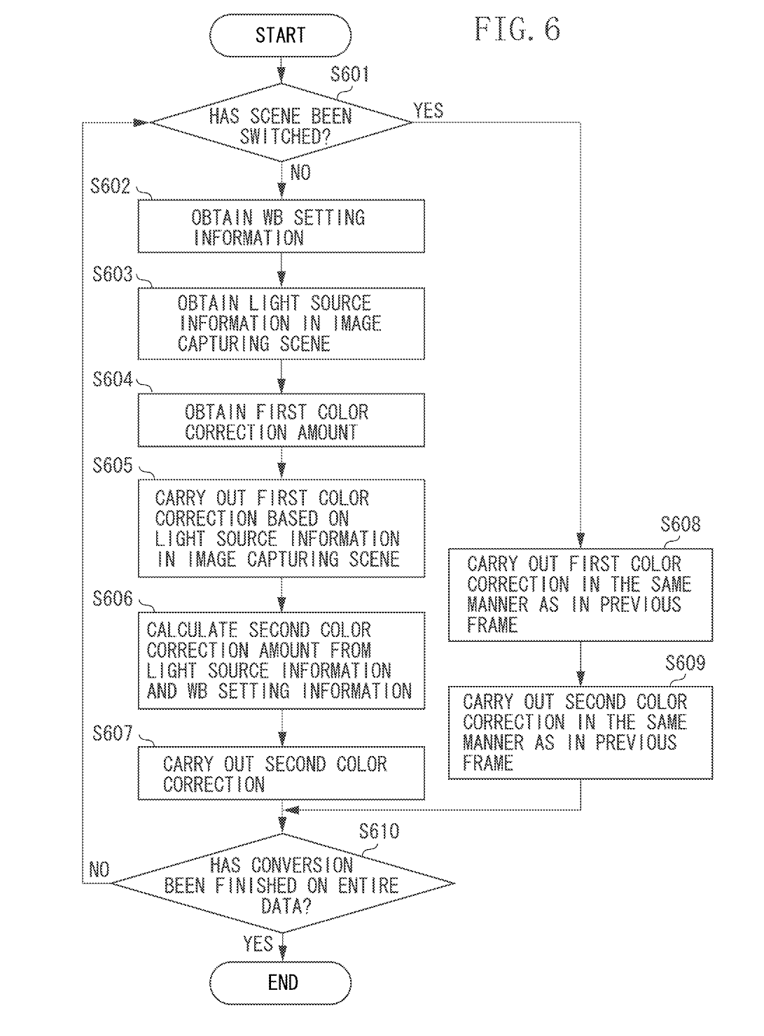

FIG. 6 is a flowchart of the image processing according to the second exemplary embodiment.

In step S601, the scene switching determination unit 501 analyzes captured moving image data to determine whether a scene has been switched. This determination can be made through any given method. For example, the scene switching determination unit 501 may make a determination based on recording time data appended to the captured moving image data. Alternatively, the scene switching determination unit 501 may make a determination based on the magnitude of a change found by analyzing the RGB signal information in the image. If a scene has been switched (Yes in step S601), the processing proceeds to step S602. If a scene has not been switched (No in step S601), the processing proceeds to step S608.

Processes in steps S602 to S607 are the same as those in steps S401 to S406 of the first exemplary embodiment.

In step S608, it has been determined that a scene has not been switched, and the first image conversion unit 304 carries out the same processing as the processing carried out in a previous frame.

In step S609, the second image conversion unit 306 carries out the same processing as the processing carried out in a previous frame.

In step S610, it is determined whether the conversion has been finished on the entire frames of the moving image. If the conversion has not been finished on the entire frames (No in step S610), the processing returns to step S601.

As described thus far, in the second exemplary embodiment, switching of the shooting scene is detected from the captured moving image data, and in accordance with the switching of the shooting scene, color correction based on the illumination information of the shooting scene and color correction based on the white balance setting information set by the user are carried out. Thus, the color can be corrected with high accuracy in accordance with the shooting scene. In addition, since the illumination information of the shooting scene and the white balance setting information only need to be acquired according to switching of the shooting scene, the illumination information of the shooting scene and the white balance setting information do not need to be acquired with respect to the entire frames of the moving image, and thus the processing load can be reduced. Although the present disclosure has been described based on the configuration including the digital video camera and the computer system in the second exemplary embodiment, similar processing can be implemented even in a configuration that includes only the digital video camera which integrates the processing of the computer system therein.

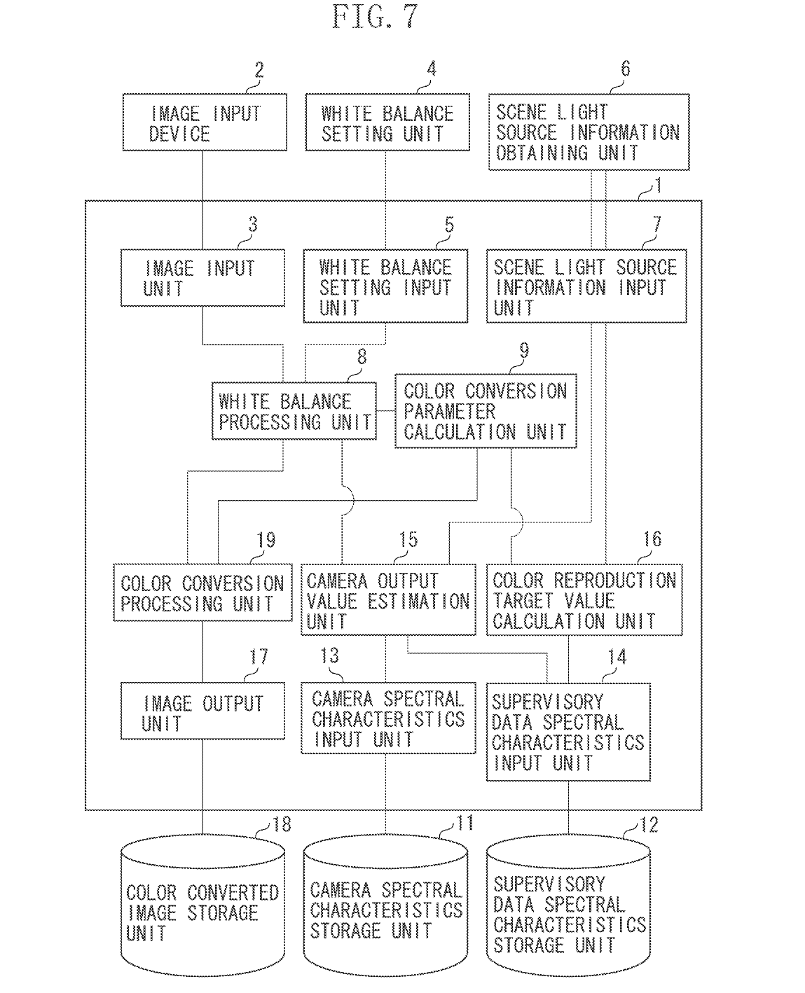

The configuration of an image processing apparatus according to a third exemplary embodiment will now be described with reference to the block diagram illustrated in FIG. 7. An image processing apparatus 1 is connected to an image input device 2, a white balance setting unit 4, and a scene light source information obtaining unit 6 and inputs/outputs various pieces of data.

The image input device 2, which is, for example, a digital camera or a digital video camera, shoots a scene or an object and converts the result to image data. An image input unit 3 inputs the image data captured by the image input device 2 to the image processing apparatus 1. The white balance setting unit 4 sets a parameter to be used in the white balance processing of the captured scene. A white balance setting input unit 5 loads the parameter for the white balance processing set by the white balance setting unit 4 onto the image processing apparatus 1. The scene light source information obtaining unit 6 sets the light source information of the scene captured by the image input device 2. A scene light source information input unit 7 loads the light source information of the scene set by the scene light source information obtaining unit 6 onto the image processing apparatus 1. A white balance processing unit 8 carries out the white balance processing based on the parameter for the white balance processing, which has been input through the white balance setting input unit 5. A color conversion parameter calculation unit 9 calculates a color conversion parameter for the image data captured by the image input device 2. A color conversion processing unit 19 carries out color conversion on the image data that has been subjected to the white balance processing by the white balance processing unit 8, based on the color conversion parameter calculated by the color conversion parameter calculation unit 9.

The image processing apparatus 1 is also connected to a camera spectral characteristics storage unit 11, a supervisory data spectral characteristics storage unit 12, and a color converted image storage unit 18 and inputs/outputs various pieces of data.

The camera spectral characteristics storage unit 11 stores the spectral characteristics of a camera serving as the image input device 2. The supervisory data spectral characteristics storage unit 12 stores the spectral characteristics of supervisory data to be used to calculate the color conversion parameter. A camera spectral characteristics input unit 13 loads the spectral characteristics of the camera stored in the camera spectral characteristics storage unit 11 onto the image processing apparatus 1. A supervisory data spectral characteristics input unit 14 loads the spectral characteristics of the supervisory data stored in the supervisory data spectral characteristics storage unit 12 onto the image processing apparatus 1. A camera output value estimation unit 15 estimates a camera output value based on the spectral characteristics of the supervisory data input through the supervisory data spectral characteristics input unit 14, the spectral characteristics of the camera input through the camera spectral characteristics input unit 13, and the scene light source information input through the scene light source information input unit 7. A color reproduction target value calculation unit 16 calculates a color reproduction target value based on the spectral characteristics of the supervisory data input through the supervisory data spectral characteristics input unit 14 and the scene light source information input through the scene light source information input unit 7. An image output unit 17 outputs image data that has been subjected to color conversion processing by the color conversion processing unit 19.

The color converted image storage unit 18 stores the image data output through the image output unit 17.

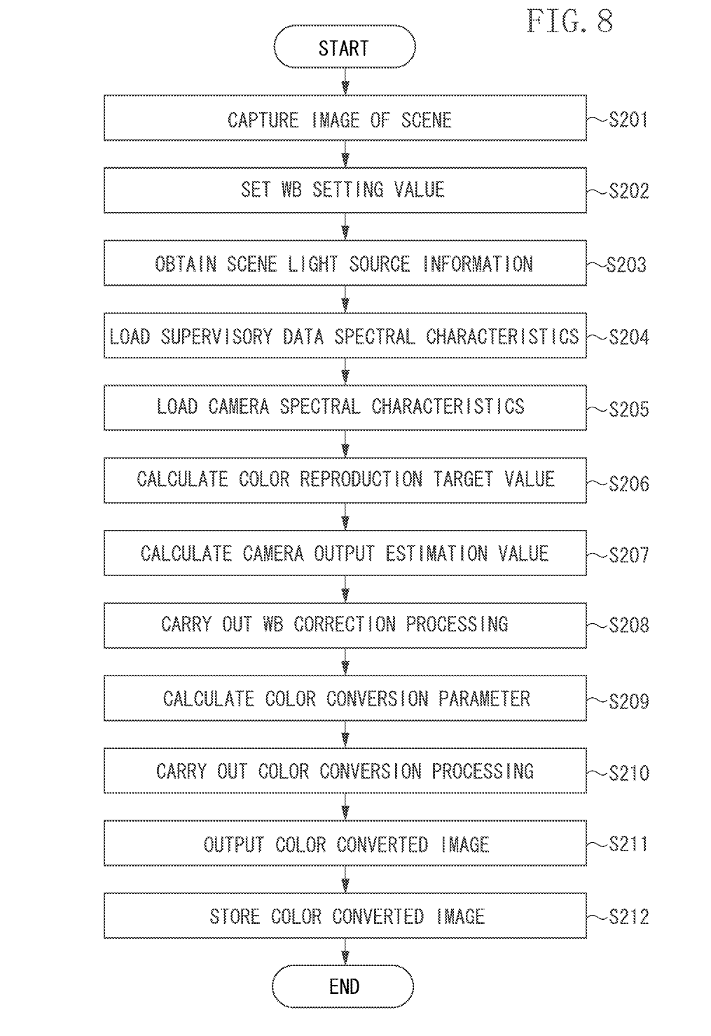

FIG. 8 is a flowchart of the image processing carried out in the third exemplary embodiment.

In step S201, the image input device 2 shoots an actual scene, and the image input unit 3 loads the captured image data onto the image processing apparatus 1.

In step S202, the user sets desired light source information as a white balance setting value by the white balance setting unit 4. The white balance setting value to be set here does not need to match the light source information of the scene. For example, in a case in which the scene light source is a tungsten light source, the value may be set to 5000 K (neutral white) or 6500 K (daylight color) in order to reflect a reddish atmosphere of tungsten on the captured image data.

In step S203, the scene light source information obtaining unit 6 obtains the actual light source information of the scene. The scene light source information obtaining unit 6 may obtain such information by setting a color temperature obtained visually by the user or measured by using a colorimeter. Alternatively, the scene light source information obtaining unit 6 may obtain such information by analyzing a color distribution of the captured image to obtain an actual color temperature of the scene, as in typical white balance processing.

In step S204, the supervisory data spectral characteristics input unit 14 loads the spectral characteristics of the supervisory data stored in the supervisory data spectral characteristics storage unit 12 onto the image processing apparatus 1.

In step S205, the camera spectral characteristics input unit 13 loads the spectral characteristics of the image input device 2 stored in the camera spectral characteristics storage unit 11 onto the image processing apparatus 1.

In step S206, the color reproduction target value calculation unit 16 calculates color reproduction target values (X_{—target} (i), Y_{—target} (i), Z_{—target} (i)). Here, the color reproduction target value calculation unit 16 carries out the processing according to Expression (11) by using the scene light source information obtained in step S203 and the spectral characteristics of the supervisory data obtained in step S204.

X_{—target}(i)=k∫_{λ}_{_{—}}₃₈₀⁷⁸⁰R(i,λ)·S_{Scene}(λ)· x̅(λ)dλ

X_{—target}(i)=k∫_{λ}_{_{—}}₃₈₀⁷⁸⁰R(i,λ)·S_{Scene}(λ)· y̅(λ)dλ

X_{—target}(i)=k∫_{λ}_{_{—}}₃₈₀⁷⁸⁰R(i,λ)·S_{Scene}(λ)· z̅(λ)dλ (11)

In the above,

$$k = \frac{100}{{\int }_{λ\_ 380}^{780} {S}_{Scene} ( λ ) \cdot \overline{y} ( λ ) d λ}$$

R(i,λ): spectral data of the i-th supervisory data
S_{Scene}(λ): spectral data of the scene light source
x̅(λ), y̅(λ), z̅(λ): color matching functions

In step S207, the camera output value estimation unit 15 calculates camera output estimation values (R(i), G(i), B(i)). Here, the camera output value estimation unit 15 carries out the processing according to Expression (12) by using the scene light source information obtained in step S203, the spectral characteristics of the supervisory data obtained in step S204, and the spectral characteristics of the camera obtained in step S205.

R(i)=k∫_{λ}_{₃₈₀}⁷⁸⁰R(i,λ)·S_{Scene}(λ)·F(r,λ)dλ

G(i)=k∫_{λ}_{₃₈₀}⁷⁸⁰R(i,λ)·S_{Scene}(λ)·F(g,λ)dλ

B(i)=k∫_{λ}_{₃₈₀}⁷⁸⁰R(i,λ)·S_{Scene}(λ)·F(b,λ)dλ (12)

In the above,

$$k = \frac{100}{{\int }_{λ\_ 380}^{780} S ( λ ) \cdot F ( g , λ ) d λ}$$

R(i,λ): spectral data of the i-th supervisory data
S_{scene}(λ): spectral data of the scene light source
F(r,λ), F(g,λ), F(b,λ): spectral transmittance of the RGB filter in the camera

In step S208, the white balance processing unit 8 carries out the white balance processing on the captured image data loaded in step S201 and the camera output estimation value calculated in step S207 according to Expression (13).

$${R}^{′} = R \frac{{G}_{WB}}{{R}_{WB}}$$

$${G}^{′} = G$$

$${B}^{′} = B \frac{{G}_{WB}}{{B}_{WB}}$$

In the above,

$$\{ \begin{matrix}{R}_{WB} = k {\int }_{λ\_ 380}^{780} R ( i , λ ) \cdot {S}_{WB} ( λ ) \cdot F ( r , λ ) d λ \\ {G}_{WB} = k {\int }_{λ\_ 380}^{780} R ( i , λ ) \cdot {S}_{WB} ( λ ) \cdot F ( g , λ ) d λ \\ {B}_{WB} = k {\int }_{λ\_ 380}^{780} R ( i , λ ) \cdot {S}_{WB} ( λ ) \cdot F ( b , λ ) d λ\end{matrix}$$

S_{WB}(λ): spectral data of the light source for white balance set in the white balance setting

In step S209, the color conversion parameter calculation unit 9 carries out optimization processing on a color conversion parameter (M) through the color conversion expressed by Expression (14) to convert the camera output estimation value so that a deviation from the color reproduction target value calculated in step S206 decreases.

$$[ \begin{matrix}X ( 1 ) & X ( 2 ) & … & X ( N ) \\ Y ( 1 ) & Y ( 2 ) & … & Y ( N ) \\ Z ( 1 ) & Z ( 2 ) & … & Z ( N )\end{matrix} ] = M [ \begin{matrix}{R}^{′} ( 1 ) & {R}^{′} ( 2 ) & … & {R}^{′} ( N ) \\ {G}^{′} ( 1 ) & {G}^{′} ( 2 ) & … & {G}^{′} ( N ) \\ {B}^{′} ( 1 ) & {B}^{′} ( 2 ) & … & {B}^{′} ( N )\end{matrix} ]$$

In the above,

$$M = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] \qquad ( 14 )$$

In step S210, the color conversion processing unit 19 transforms the captured image data that has been subjected to the white balance processing, to XYZ values by using the color conversion parameter calculated in step S209 and then transforms the obtained XYZ values to RGB values by using typical processing for transforming XYZ values to RGB values. Here, the color space of the output RGB values may be, for example, the sRGB color space or the Adobe RGB color space if the image input device 2 is a digital camera, or the ACES color space or the digital cinema initiatives (DCI) color space if the image input device 2 is a cinema camera. However, the color space is not limited to any special space.

In step S211, the image output unit 17 outputs the color converted image that has been subjected to the color conversion in step S210.

In step S212, the color converted image storage unit 18 stores the color converted image output in step S211.

### <Spectral Characteristics of Supervisory Data>

The spectral characteristics of the supervisory data obtained in step S204 above may, for example, be obtained by using values in a typical spectral database, such as the standard object color spectra database (SOCS) or by using a measured value of a color (e.g., skin color or green of plant) which a camera manufacturer considers to be important in color reproduction. Alternatively, spectral data of a color which the user considers to be important may be prepared and loaded.

### <Camera Spectral Characteristics>

The spectral characteristics of the camera obtained in step S205 above are desirably the spectral characteristics of the entire image input device 2 including a lens or a sensor, instead of the spectral characteristics of only an RGB color filter.

### <White Balance Processing>

Although the RGB values of the light source for the white balance have been calculated from the spectral data according to Expression (13) above, an exemplary embodiment is not limited to this method. For example, RGB values (R_{WB}, G_{WB}, B_{WB}) corresponding to the white balance setting may be prepared in advance, and (R_{WB}, G_{WB}, B_{WB}) may be selected in accordance with the obtained white balance setting.

### <Camera Output Value Estimation>

Although the estimation value of the camera output calculated in step S207 above has been calculated based on the spectral data according to Expression (12), an exemplary embodiment is not limited thereto. For example, an image of a color chart with known colorimetric values may actually be captured, and the RGB values of the actually captured image data may be used.

As described above, according to the third exemplary embodiment, the color conversion parameter is generated by using the white balance setting value set by the user and the light source information of the actually captured scene, and thus suitable color conversion can be carried out.

In the third exemplary embodiment, a method has been described in which the color conversion parameter is calculated after shooting by using the spectral characteristics of the supervisory data and the spectral characteristics of the camera. In a fourth exemplary embodiment, a method will be described in which color conversion parameters are generated for a plurality of white balance settings and a plurality of pieces of scene light source information in advance and a suitable color conversion parameter is selected from the calculated color conversion parameters.

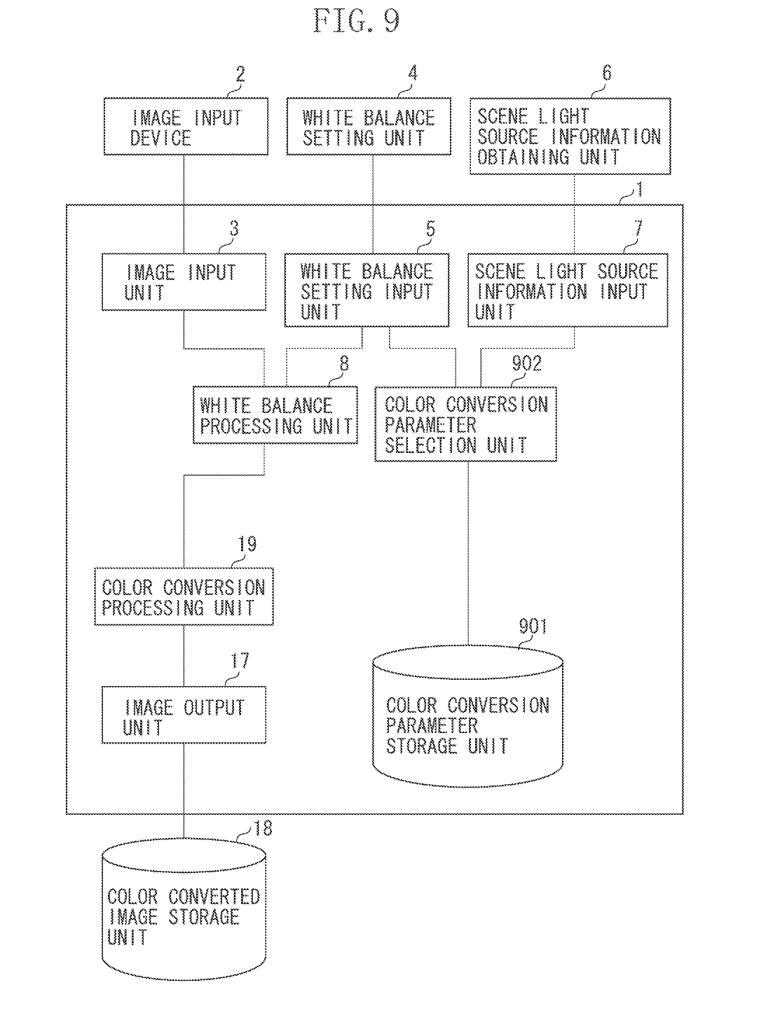

FIG. 9 is a block diagram of an image processing apparatus according to the fourth exemplary embodiment. Here, primarily, features that differ from those of the third exemplary embodiment will be described in brief.

A color conversion parameter storage unit 901 stores color conversion parameters, generated in advance, corresponding to a plurality of white balance settings and a plurality of pieces of scene light source information.

A color conversion parameter selection unit 902 selects a suitable parameter from among the color conversion parameters stored in the color conversion parameter storage unit 901, based on the obtained white balance setting value and the scene light source information.

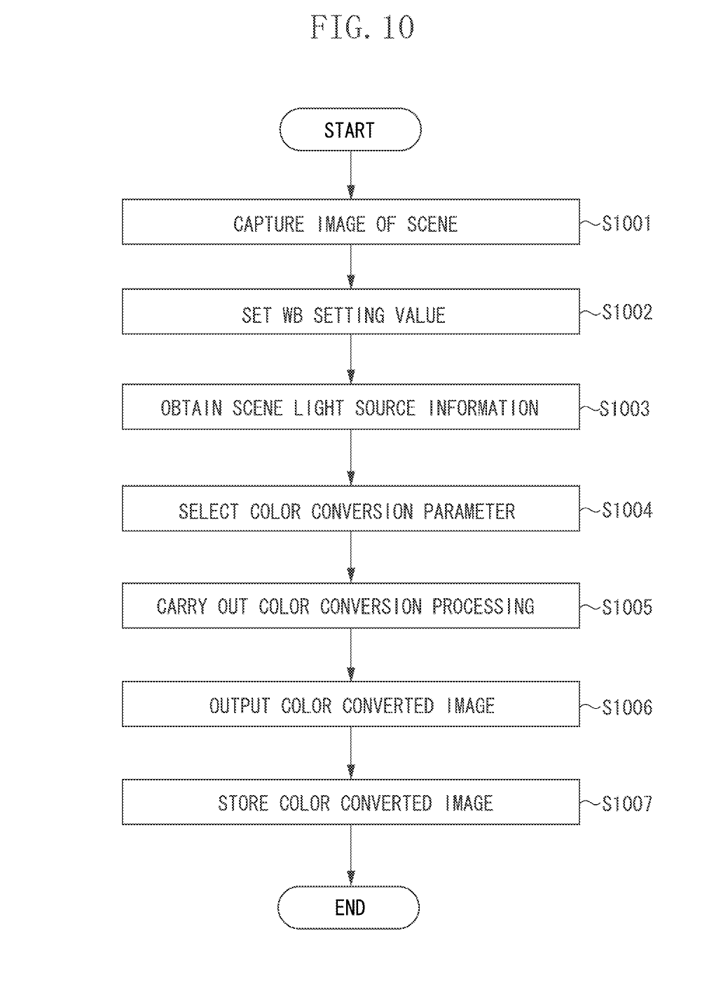

FIG. 10 is a flowchart of the image processing carried out in the fourth exemplary embodiment. Processes in steps S1001 to S1003 and S1005 to S1007 are identical to the processes in steps S201 to S203 and S210 to S212 in the third exemplary embodiment, and thus descriptions thereof will be omitted.

In step S1004, the color conversion parameter selection unit 902 carries out the following processing. Specifically, the color conversion parameter selection unit 902 selects a suitable one from among the color conversion parameters stored in the color conversion parameter storage unit 901, based on the white balance setting value obtained in step S1002 and the scene light source information obtained in step S1003.

<Method for Selecting from Plurality of Color Conversion Parameters>

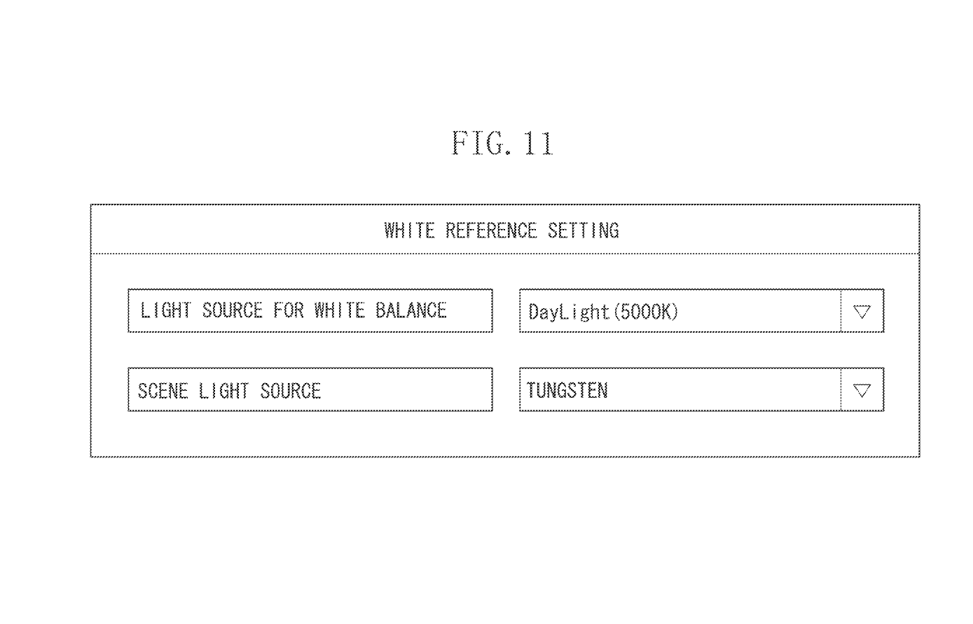

With regard to the color conversion parameter to be selected in step S1004, a plurality of white balance setting values and a plurality of pieces of scene light source information may be prepared in advance, and a color conversion parameter calculated under a condition closest to the obtained white balance setting value and the scene light source information may be selected. Here, the user may, for example, make a selection from the light sources for the white balance and from the scene light sources prepared in advance, by using a pull-down system or the like in a user interface such as the one illustrated in FIG. 11.

### <Gradation Characteristics of Camera>

In the third and fourth exemplary embodiments described above, descriptions on the gradation characteristics of the camera have been omitted for the sake of simplicity. In an actual camera, an output value may not be in a linear relationship with the reflectance of the object or the luminance due to the sensor characteristics, the internal image processing, and so on. Thus, it is desirable to carry out gradation conversion processing so that the output value of the sensor has a linear relationship with the reflectance of the object or the luminance.

As described thus far, according to the fourth exemplary embodiment, an optimal parameter is selected from among color conversion parameters by using the white balance setting value set by the user and the light source information of the actually captured scene, and thus optimal color conversion can be carried out.

The present disclosure can also be realized by supplying a recording medium on which software program codes that realize the functions of the exemplary embodiments described above (e.g., steps illustrated in the flowcharts described above) are recorded, to a system or an apparatus. In this case, a computer (or CPU, microprocessing unit (MPU)) of the system or the apparatus loads the program codes stored in the computer readable storage medium and executes the program codes to realize the functions of the exemplary embodiments described above. In addition, the program may be executed either by a single computer or by a plurality of interconnected computers.

The present disclosure makes it possible to improve color conversion accuracy even in a case of shooting a scene with a white balance that differs from light source characteristics of the shooting scene.

### Other Embodiments

Embodiments of the present disclosure can also be realized by a computer of a system or apparatus that reads out and executes computer executable instructions recorded on a storage medium (e.g., a non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2013-101518 filed May 13, 2013, which is hereby incorporated by reference herein in its entirety.

What is claimed is:

1. An image processing apparatus comprising:
a first conversion unit configured to convert captured image data based on light source information under shooting illumination; and
a second conversion unit configured to convert captured image data that has been converted by the first conversion unit, based on white balance setting information and the light source information.

2. The image processing apparatus according to claim 1, wherein the light source information is a value that represents a white color under the shooting illumination.

3. The image processing apparatus according to claim 1,
wherein the captured image data is a red, green, and blue (RGB) signal, and
wherein the light source information is an RGB signal in which a signal value of green in the RGB signal is highest in the captured image data.

4. The image processing apparatus according to claim 1, wherein the setting information is information that indicates shooting illumination set when the captured image data is captured.

5. The image processing apparatus according to claim 1, wherein the setting information is information set by a user instruction.

6. The image processing apparatus according to claim 1, wherein the first conversion unit selects a transformation matrix that corresponds to the light source information of the shooting illumination from a plurality of transformation matrices prepared in advance in correspondence with the light source information, and converts the captured image data by using the selected transformation matrix.

7. The image processing apparatus according to claim 1, wherein the second conversion unit obtains a correction amount for visual sensitivity based on the setting information and the light source information, and converts the captured image data that has been converted by the first conversion unit based on the correction amount.

8. The image processing apparatus according to claim 1, wherein the image processing apparatus is one of a digital still camera and a digital video camera.

9. The image processing apparatus according to claim 1,
wherein the captured image data is moving image data,
wherein the image processing apparatus further includes a determination unit configured to determine whether there is a scene switch in the captured moving image data, and
wherein the first conversion unit and the second conversion unit carry out conversion in response to the scene switch.

10. The image processing apparatus according to claim 1, wherein the second conversion unit converts the captured image data that has been converted by the first conversion unit by carrying out optimization processing based on the white balance setting information and the light source information of the shooting illumination, while using spectral characteristics of supervisory data prepared in advance and spectral characteristics of an image input device that captures the image data.

11. A storage medium storing a program that causes a computer to function as each unit in an image processing apparatus comprising:
a first conversion unit configured to convert captured image data based on light source information under shooting illumination; and
a second conversion unit configured to convert captured image data that has been converted by the first conversion unit, based on white balance setting information and the light source information.

12. An image processing method comprising:
first converting, by a first conversion unit, captured image data based on light source information under shooting illumination; and
second converting, by a second conversion unit, captured image data that has been converted in the first converting, based on white balance setting information and the light source information.
